(19) United States
(12) Patent Application Publication
(10) Pub. No.: US 2024/0344659 A1
(43) Pub. Date: Oct. 17, 2024

(54) PRESSURE VESSEL COMPRISING AN INTERIOR CHAMBER, AND METHOD FOR MANUFACTURING A PRESSURE VESSEL

(71) Applicant: FRAUNHOFER-GESELLSCHAFT ZUR FÖRDERUNG DER ANGEWANDTEN FORSCHUNG E.V., München (DE)

(72) Inventors: Henning JANSSEN, Aachen (DE); Martin SCHÄKEL, Aachen (DE); Philip JONGEBLOED, Aachen (DE)

(21) Appl. No.: 18/580,297

(22) PCT Filed: Jun. 30, 2022
(86) PCT No.: PCT/DE2022/100474

§ 371 Date: Jan. 18, 2024

(30) Foreign Application Priority Data
Jul. 21, 2021 (DE) 102021118904.7

(51) Int. Cl. F17C 1/02

(52) U.S. Cl. CPC F17C 1/02; F17C 2201/0104; F17C 2203/0604; F17C 2203/0663; F17C 2221/012

(57) ABSTRACT

The invention relates to a pressure vessel (1) with an interior chamber (30), in particular for storing hydrogen, comprising a vessel wall (12) which has or consists of a composite material unit (14, 22, 26) with reinforcing fibers (16) and a thermoplastic plastic matrix (18), wherein the composite material unit (14, 22, 26) is arranged and configured such that the reinforcing fibers (16) can be removed as continuous fibers, in particular non-destructively, so that the composite material unit can be reused.

The invention relates to a pressure vessel with an interior chamber, in particular for storing hydrogen, and to a method for producing a pressure vessel, in particular a recyclable pressure vessel, with an interior chamber, in particular for storing hydrogen.

Pressure vessels are generally known. Pressure vessels are categorized into different types. Type 1 relates to a solid metal pressure vessel. Type 2 concerns a pressure vessel with a metal liner with fiber winding to reinforce the cylindrical container part. A liner is generally understood as a hollow body for forming an interior chamber of the pressure vessel. Type 3 relates to a pressure vessel with a metal liner with essentially complete fiber winding for reinforcement. Type 4 relates to a pressure vessel with a plastic liner with complete fiber winding for reinforcement. Type 5 relates to pressure vessels without a liner with complete formation of the vessel wall by means of fiber winding.

Pressure vessels are used for different applications and in different sizes. Due to the increasing importance of alternative drive technologies for vehicles, pressure vessels are increasingly being applied in mobile applications or are used to transport gases. In order to meet the high safety requirements for mobile applications and transport, pressure vessels with fiber-reinforced walls are primarily used for these applications. Furthermore, pressure vessels with fiber composite-reinforced walls generally offer the advantage of low weight, so that a greater range of the vehicle is possible for mobile applications and transport. In addition, the high strength of pressure vessels with fiber composite-reinforced walls enables a high energy storage density, so that vehicles with such a pressure vessel applied as a fuel tank have a longer range.

The high number of pressure vessels that can be produced in such a way puts recyclability at the forefront. Up to now, pressure vessels made of thermoset fiber composite plastics have mainly been applied for hydrogen applications, for example, as they are easy to manufacture using established methods. It is generally not possible to reshape pressure vessels made of thermoset fiber composites once they have cured.

Recycling processes for such pressure vessels are essentially limited to destroying the material at least partially mechanically, thermally and/or chemically. One possibility, in particular, is to mechanically crush the pressure vessel in hammer mills or granulators, for example to chop it up. The quality and homogeneity of the recyclate is usually reduced by mechanical shredding, as the fibers are present in a non-uniform and shortened form and length.

Thermal recycling processes comprise material incineration for energy recovery and decomposition of the matrix plastic by pyrolysis. The matrix plastic is essentially completely dissolved in these methods. The properties of the fibers are impaired compared to their original state, meaning that these fibers can only be used for applications with lower requirements.

In chemical recycling processes, the matrix plastic is removed by solvolysis using solvents. The energy required is lower compared to thermal recycling processes, but cost-intensive reactors and catalysts are required for the method.

An alternative to the use of thermoset fiber composites is the use of thermoplastic fiber composites, which have different properties. Components made of thermoplastic fiber composites are usually also recycled by shredding, whereby the resulting material has impaired mechanical properties compared to the starting material.

DE 10 2016 117 559 A1 describes a method and a device for recycling thermoplastic fiber composite materials. This method provides for the recycling of thermoplastic fiber composite material by removing it layer by layer from a component and obtaining it as a recyclate. This method can also involve heating the fiber composite material in order to facilitate detachment. When using this method, it has been shown that it is time-consuming for components with a large number of fiber composite materials applied in layers. In particular, the starting process on surfaces with limited accessibility or highly curved surfaces can only be automated to a limited extent. In particular, the time and manual effort required for recycling reduce the efficiency of the method.

DE 10 2017 220 882 A1 discloses a pressure vessel with a reinforcement made of thermoplastic and thermoset. The publication “Christ, Timo Klaus: Dissertation. Computational and experimental investigations into the failure behavior of CFRP-wrapped cryogenic pressure vessels. Technische Universität München zur Erlangung des akademischen Grades eines Doktor-Ingenieurs (Dr.-Ing.): 28.11.2017 URL: https://mediatum.ub.tum.de/doc/1366807/1366807.pdf [retrieved on 01.04.2022]” discloses various construction methods for pressure vessels.

It is therefore an object of the invention to provide a pressure vessel with an interior chamber, in particular for storing hydrogen, and a method for producing a pressure vessel with an interior chamber, which reduce or eliminate one or more of the aforementioned disadvantages. In particular, it is an object of the invention to provide a solution that enables the recycling of a pressure vessel at a low cost. Furthermore, it is an object of the invention to provide an alternative for a recyclable pressure vessel.

This problem is solved with a pressure vessel and a method according to the features of the independent patent claims. Further advantageous embodiments of these aspects are given in the respective dependent patent claims. The features listed individually in the patent claims and the description can be combined with one another in any technologically expedient manner, whereby further embodiments of the invention are shown.

According to a first aspect, the problem is solved by a pressure vessel with an interior chamber comprising a vessel wall which has or consists of a composite material unit with reinforcing fibers and a thermoplastic plastic matrix, wherein the composite material unit is arranged and configured in such a way that the reinforcing fibers can be removed as continuous fibers, in particular non-destructively, so that the composite material unit can be reused.

The invention is based on the knowledge that the reusability or recyclability of thermoplastic fiber composites can be improved by component-specific recycling properties. In particular, the high time expenditure mentioned above and the limited automation of the starting process on surfaces with limited accessibility or highly curved surfaces can be reduced by a pressure vessel whose composite material unit is arranged and configured in such a way that the reinforcing fibers of the composite material unit can be removed as continuous fibers.

Furthermore, the invention is based on the realization that the recycling rate can be increased with such a pressure vessel. The inventors have found that the mechanical forces required for the recycling process as well as the high temperatures can be reduced with such a pressure vessel. In addition, there is no need to provide reactors for chemical recycling processes.

The pressure vessel enables high-quality recycling. The recyclates that can be recovered from this pressure vessel can be reused to manufacture high-quality products from continuous fiber semi-finished products. This makes the recycled material obtained from pressure vessels at the end of their life cycle available for reuse in existing manufacturing processes and saves energy and costs in material production. A pressure vessel configured in such a way or the composite material unit comprised by the pressure vessel is advantageously recyclable or reusable because, among other things, the solid structure of the composite material unit can be dissolved by removing the reinforcing fibers and at least partially removing the thermoplastic matrix.

The existing similarity of the material properties to those of new semi-finished products makes it possible for the first time to use fiber-reinforced plastics in the sense of the circular economy. In particular, a pressure vessel designed in such a way and explained in more detail below can be recycled at the end of its service life and the processed materials can be reused.

The pressure vessel is a reusable pressure vessel, in particular for storing fluid, preferably a gas, in particular hydrogen, preferably liquid gas, in particular liquid hydrogen. The pressure vessel has the interior chamber, which is configured in particular for storing hydrogen, preferably liquid hydrogen. The interior chamber can also be understood as a cavity. The interior chamber may have one, two or more openings through which a fluid can be filled or can escape.

The pressure vessel comprises the vessel wall. The vessel wall at least partially encloses the interior chamber. The vessel wall is preferably arranged and configured to allow a nominal pressure of greater than or equal to 100 bar, greater than or equal to 200 bar, greater than or equal to 350 bar or greater than or equal to 700 bar. A hollow body, which is explained in more detail below, can be arranged between the vessel wall and the interior chamber. The vessel wall comprises or consists of the composite material unit.

The composite material unit has reinforcing fibers and a thermoplastic matrix. The composite material unit can be a thermoplastic tape, for example. The composite material unit may, for example, be a composite material tape configured in tape and/or filament form. Furthermore, the reinforcing fibers and the thermoplastic plastic matrix of the composite material unit can be fed individually and bonded together when producing the pressure vessel.

The reinforcing fibers can be carbon fibers or glass fibers, for example. Carbon fibers and glass fibers have the advantage that they are thermally stable at the melting temperature of thermoplastic resin matrices. Furthermore, other reinforcing fibers known to the person skilled in the art can also be applied, such as polymeric fibers. The composite material unit is in particular a processed thermoplastic continuous fiber semi-finished product with continuous fibers. The continuous fibers of the thermoplastic continuous fiber semi-finished product are preferably arranged and/or aligned unidirectionally. Furthermore, additional fiber orientations of the continuous fibers of the thermoplastic continuous fiber semi-finished product deviating from the unidirectional arrangement and/or orientation can also be provided. The thermoplastic continuous fiber semi-finished product is also referred to as UD tape. The composite material unit preferably has a fiber volume content which is also preferably more than 30%, more than 40%, in particular more than 50%.

The composite material unit is arranged and configured such that the reinforcing fibers are removable as continuous fibers. This allows the reinforcing fibers to be almost completely present in high quality after removal. Continuous fibers are understood to be, in particular, such reinforcing fibers that have a length of more than 50 mm, more than 100 mm, more than 1 m, more than 10 m, more than 100 m or more than 1000 m. The fact that the reinforcing fibers are removable as continuous fibers can mean, for example, that the reinforcing fibers can be removed essentially non-destructively.

That the composite material unit is reusable means, in particular, that the reinforcing fibers and, in some cases, the thermoplastic matrix can be removed in such a way that they can subsequently be reused. This may include rolling the composite material unit to be reused or adding matrix material to it.

It is further preferred that the composite material unit is arranged to be removable as such, so that essentially the reinforcing fibers and the plastic matrix are removable. It is particularly preferred that the plastic matrix is completely or partially non-destructively removable with the reinforcing fibers, so that the composite material unit itself is substantially non-destructively removable. Essentially non-destructively removable means, for example, that more than 20%, more than 30%, more than 40% or more than 50% of the reinforcing fibers are present as continuous fibers after removal.

The pressure vessel can also be configured to store natural gas. The pressure vessel can also be configured to store compressed air. Furthermore, it is preferred that the pressure vessel is intended for mobile applications on the road, rail, in aviation or also for stationary applications and transportation.

The composite material unit can, for example, be processed into the vessel wall using an additive winding process. In the additive winding process, the layers of the composite material unit can be consolidated both during winding, i.e. in-situ, and/or subsequently. The reinforcing fiber and the plastic matrix can also be combined to form the composite material unit during component manufacture.

A preferred embodiment of the pressure vessel is characterized by the fact that the composite material unit is arranged and configured in such a way that the thermoplastic matrix with the reinforcing fibers can be removed. A pressure vessel configured in such a way has the advantage that the composite material unit can be removed essentially non-destructively, so that it can, for example, be wound up and then used again for producing a component, such as a pressure vessel. It is therefore not necessary to separate the reinforcing fibers and the plastic matrix. As a result, a particularly high degree of recycling of the pressure vessel is possible and little effort is required to reprocess the removed composite material unit.

In particular, good adhesion between the reinforcing fibers and the plastic matrix of the composite material unit advantageously influences the removal of the composite material unit.

A further preferred embodiment of the pressure vessel provides that the composite material unit extends from an arrangement start to an arrangement end and a detachment section of the composite material unit adjacent to the arrangement end is arranged and/or configured to be detachable.

In particular, the composite material unit is first arranged with the arrangement start, then with a section between the arrangement start and the arrangement end and finally with the arrangement end. In the case of a wound pressure vessel, for example, the arrangement start is the winding start and the arrangement end is the winding end. The arrangement start is preferably at a smaller distance from the interior chamber in a radial direction of the pressure vessel than the arrangement end.

In particular, the detachment section is arranged and/or configured so that it can be detached non-destructively. In particular, the detachment section is arranged and/or configured to be detachable from a substrate, which may be, for example, a composite material unit, the composite material unit or a hollow body. Arranged and/or configured to be detachable means in particular that the detachment section can be detached from the substrate with less force and/or with less effort than the rest of the composite material unit.

A defined detachment section allows the composite material unit to be gripped more easily, making it easier to detach the composite material unit. In particular, the advantageously accessible wrapping area can be influenced mechanically and/or thermally.

In a further preferred embodiment of the pressure vessel, it is provided that the detachment section has a strength-reducing detachment layer on a side of the composite material unit facing the interior chamber.

The release layer may, for example, consist of or comprise a material different from the material of the composite material unit. The material of the release layer can be plastic, for example. In addition, the intermediate layer may comprise or consist of a fiber composite material that has a higher matrix material content than the composite material unit. It is also preferred that the release layer has additional elements, for example nanoparticles and/or short fibers.

In a further preferred embodiment of the pressure vessel, it is provided that the detachment section is partially consolidated, so that a bond strength, in particular a shear strength, of the detachment section is lower than a bond strength of a consolidated section of the composite material unit. The partial consolidation of the detachment section can be configured, for example, by a lower temperature, a lower pressure and/or a higher speed when producing the pressure vessel.

The bond strength of the partially consolidated detachment section can preferably be between 5 MPa and 30 MPa, for example 20 MPa, and the bond strength of the consolidated section can preferably be between 30 MPa and 80 MPa, for example 50 MPa. The bond strength, preferably the shear strength, relates in particular to a strength of the detachment section with a substrate.

The substrate is, for example, a section of another or the composite material unit lying under the detachment section. A detachment section configured in such a way can be produced directly during producing and essentially no additional process steps and/or materials are required.

A further preferred embodiment of the pressure vessel is characterized in that the detachment section extends from the arrangement end with a detachment extension, and the detachment extension is more than 1 millimeter, more than 2 millimeters, more than 5 millimeters, more than 10 millimeters and/or less than 100 millimeters, less than 50 millimeters, less than 25 millimeters, less than 15 millimeters, less than 10 millimeters.

It is further preferred that the pressure vessel comprises two or more, preferably a plurality of, composite material units each having an arrangement end. The length of a single composite material unit can be, for example, 100 meters to 2000 meters. It is particularly preferred that the pressure vessel comprises 5 to 15, for example 10, composite material units. Preferably, 20-150 layers, in particular 50-100 layers, can thus be configured on top of each other. It is further preferred that the composite material unit is a composite material web.

In a further preferred embodiment of the pressure vessel, the pressure vessel comprises a cylindrical vessel portion having a cylindrical circumferential direction, wherein a first composite material unit is arranged along the cylindrical circumferential direction of the vessel portion and/or a second composite material unit is arranged at an angle, in particular orthogonally, to the cylindrical circumferential direction.

Along the cylinder circumferential direction means in particular that a main extension direction or a longitudinal direction of the first composite material unit is aligned essentially parallel to the cylinder circumferential direction. Essentially can mean, for example, that there is a degree deviation of less than 15 degrees, less than 10 degrees, less than 5 degrees, less than 2.5 degrees between the main extension direction or longitudinal direction of the first composite material unit and the cylinder circumferential direction. This deviation can also be defined with the winding angle, whereby a degree deviation of 10 degrees corresponds to a winding angle of 80 degrees. The second composite material unit can, for example, be a cross layer and/or a local reinforcement layer.

Preferably, the pressure vessel has a first dome section. Furthermore, it is preferred that the pressure vessel has a second dome section. Preferably, the cylindrical vessel portion is arranged between the first dome portion and the second dome portion. In a preferred embodiment of the pressure vessel, it is provided that the second composite material unit wraps around the cylindrical vessel portion, the first dome portion and the second dome portion.

According to a further preferred embodiment of the pressure vessel, it is provided that more than 50%, more than 75%, more than 90%, in particular more than 95% of the arrangement ends are arranged within the cylindrical vessel portion.

Within the cylindrical vessel portion means, in particular, that the arrangement ends are adjacent to the cylindrical vessel portion and, in particular, are not arranged within the dome portions. The arrangement ends are thus more accessible for removing the composite material units and, in addition, they are located outside the locations with complex stress states and geometry changes, which are usually located in the dome sections.

Furthermore, it is preferred that the arrangement ends are substantially evenly distributed along a vessel surface of the pressure vessel and/or in the cylindrical vessel portion. Essentially evenly distributed means, for example, that the arrangement ends are essentially equally spaced from one another in the direction of the container surface. It is particularly preferred that the arrangement ends are arranged at different positions on the container surface, in particular in the cylindrical vessel portion.

According to a further preferred embodiment of the pressure vessel, it is provided that the pressure vessel comprises a hollow body forming the interior chamber, in particular a liner, wherein the composite material unit or the composite material units is or are arranged on an outer side of the hollow body and/or the composite material unit faces the outer side with an underside. Such a pressure vessel can be manufactured at a particularly low cost.

According to a further aspect, the problem mentioned at the beginning is solved by a method for producing a pressure vessel, in particular a recyclable pressure vessel, with an interior chamber, in particular for storing fluid, for example hydrogen, preferably liquid hydrogen, in particular a pressure vessel according to one of the embodiments described above, comprising the step of: producing a vessel wall with a composite material unit with reinforcing fibers and a thermoplastic plastic matrix, wherein the composite material unit is arranged and configured in such a way that the reinforcing fibers can be removed non-destructively.

In particular, the method is an additive winding method. Preferably, the method comprises in-situ consolidation of the composite material unit by application of force and/or heat. Furthermore, the additive winding method may comprise a partial consolidation of the composite material unit, wherein the partially consolidated composite material unit is subsequently consolidated. The subsequent consolidation can, for example, take place in an overpressure environment with thermal influence, in particular in an autoclave.

A preferred embodiment of the method provides that the composite material unit has an arrangement end, wherein the method comprises the steps of: Detecting an arrangement end position of the arrangement end on the pressure vessel, and generating and providing data characterizing the arrangement end position. The arrangement end position of the arrangement end can, for example, be determined relative to a reference point on the pressure vessel.

It is preferred that a detachment section is configured adjacent to the arrangement end. In particular, it is preferred that the detachment section is partially consolidated so that it has a reduced joint strength.

Further preferably, the method comprises the step of: performing a path planning for planning directions in which the composite material unit is arranged.

Further preferably, the method comprises the step of: Detecting a temperature, a pressure, tape properties and/or consolidation properties, and generating and providing data characterizing one, two or more of the parameters mentioned in the foregoing.

A further preferred embodiment of the method provides that the composite material unit is arranged with a direction of arrangement, comprising the steps of: detecting the direction of arrangement of the composite material unit and generating and providing data characterizing the direction of arrangement. The arrangement direction is at least substantially equal to the fiber direction or the fiber orientation.

The data characterizing the arrangement direction and/or the arrangement end position can, for example, be provided to a CAD and/or CAM system.

Preferably, the pressure vessel has a plurality of arrangement end positions and/or arrangement directions, wherein the method comprises the step of: Generating and providing data characterizing the arrangement end positions and/or the arrangement directions.

A further preferred embodiment of the method comprises the step of: generating a digital image of the pressure vessel based on data characterizing the arrangement end positions or the arrangement positions and/or based on data characterizing the arrangement direction or the arrangement directions. The digital image can further be generated based on data characterizing a pressure vessel geometry of the pressure vessel. Such a digital image can also be referred to as a digital twin. In particular, the digital image represents a geometry, one, two or more dimensions of the pressure vessel and/or the final arrangement positions. Furthermore, the digital image can represent one, two or more arrangement directions.

It is further preferred that the method comprises the step of: Aligning the pressure vessel such that a predetermined arrangement direction can be realized.

According to a further preferred embodiment of the method, a plurality of composite material units are arranged with one arrangement end each, preferably with adjacent arrangement ends being arranged next to each other.

According to a further aspect, the problem mentioned at the beginning is solved by a computer-implemented method for a digital image of a pressure vessel, comprising the steps of: receiving data characterizing a pressure vessel geometry, an arrangement end position, an arrangement direction, production parameters and/or machine parameters recorded during the producing of the pressure vessel, and generating the digital image based on the data characterizing the pressure vessel geometry, the arrangement end position, the arrangement direction, the production parameters and/or machine parameters recorded during the producing of the pressure vessel.

According to a further aspect, the problem mentioned at the beginning is solved by a computer program product comprising instructions which, when the program is executed by a processor, cause the processor to perform the steps of the computer-implemented method according to the aspect mentioned in the previous aspect.

The computer-implemented method is preferably performed by a device comprising the processor, the device further comprising, in particular, a transceiver and a memory. The processor may comprise a hardware module, which may be a logic device, an IC, an ASCI, an FPGA, a computational processing unit or the like. The processor may be a CPU or an integrated circuit in the form of a microprocessor or microcontroller.

The hardware module may further comprise a memory. The memory may be a non-volatile memory. The memory may be adapted to store data received by the memory from the processor and/or the transceiver. The memory may store a computer program product according to the aspect described above. The transceiver may be an interface adapted to send data to and/or receive data from a computer, a mobile device, a local or external network and/or a cloud.

According to a further aspect, the problem mentioned at the beginning is solved by a computer-readable data carrier on which the computer program product according to the aspect mentioned in the previous aspect is stored.

According to a further aspect, the problem mentioned at the beginning is solved by a digital image of a pressure vessel obtained by a computer-implemented method according to the aspect mentioned in the previous aspect.

The method and its possible embodiments have features or method steps which make them particularly suitable for use in producing a pressure vessel described in the preceding aspect. The method steps can also be performed partially or completely as computer-implemented method steps in the computer-implemented method.

For further advantages, embodiments and embodiment details of the further aspect and its possible embodiments, reference is also made to the previous description of the corresponding features and embodiments of the pressure vessel.

Preferred embodiments are explained by way of example with reference to the enclosed figures. The figures show:

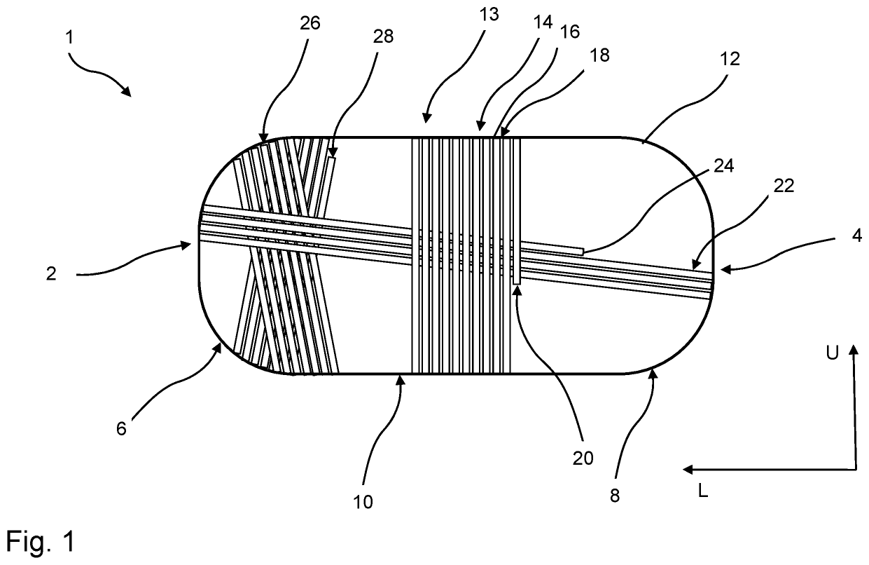

FIG. 1: a schematic, two-dimensional view of an exemplary embodiment of a pressure vessel;

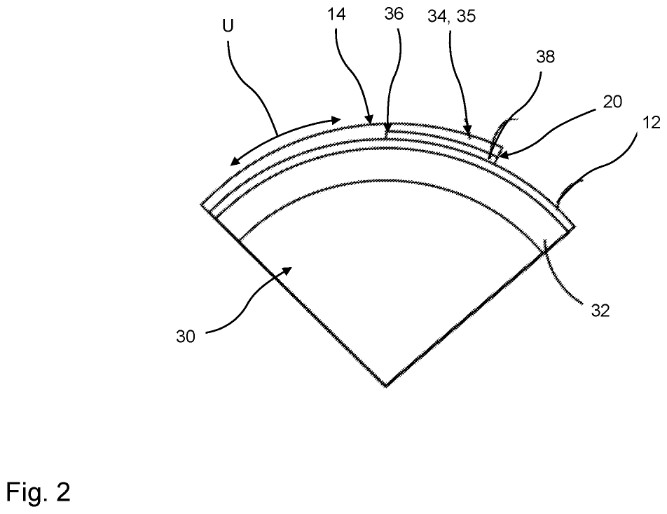

FIG. 2: a schematic, two-dimensional sectional view of a detail of the pressure vessel shown in FIG. 1;

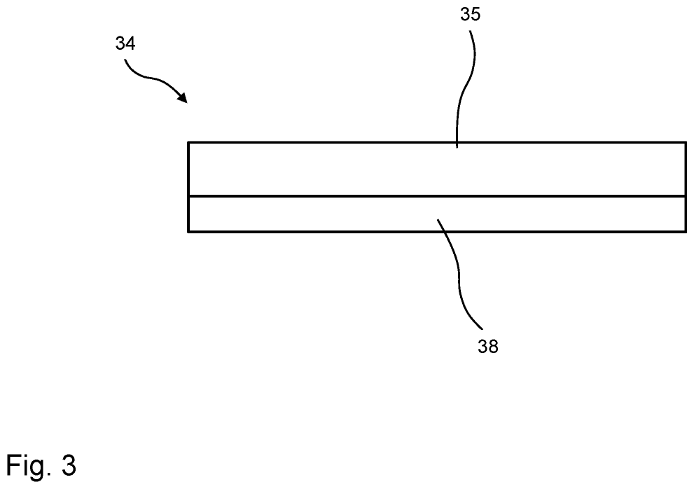

FIG. 3: a schematic, two-dimensional detailed view of a detachment section;

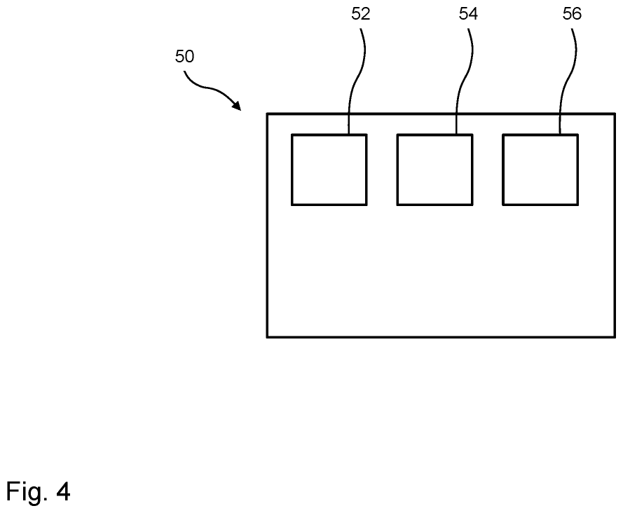

FIG. 4: a schematic representation of a device with a processor; and

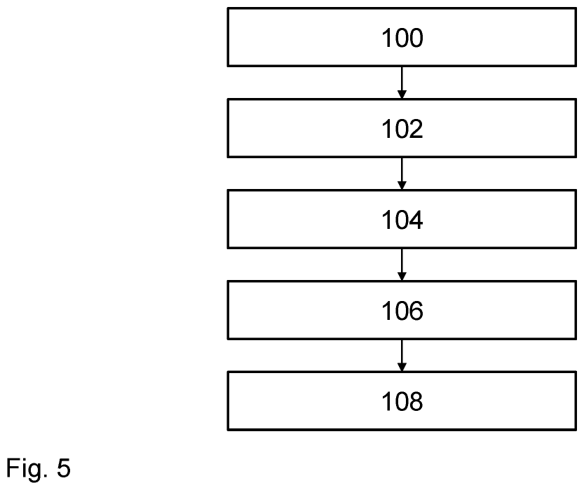

FIG. 5: a schematic representation of an exemplary method.

In the figures, identical or essentially functionally identical or similar elements are designated with the same reference signs.

The pressure vessel 1 shown in FIG. 1 extends from a first vessel end 2 to a second vessel end 4 in the longitudinal direction L. Adjacent to the first vessel end 2, the pressure vessel 1 has a first dome section 6 and adjacent to the second vessel end 4, the pressure vessel 1 has a second dome section 8. Between the first dome portion 6 and the second dome portion 8, the pressure vessel 1 has a cylindrical vessel portion 10.

The pressure vessel 1 has an interior chamber 30, shown in FIG. 2, which is substantially surrounded by a vessel wall 12. The vessel wall is shown here only schematically in order to illustrate the arrangement of three exemplary composite material units 14, 22, 26.

The first composite material unit 14 is aligned along the cylindrical circumferential direction U of the cylindrical vessel portion 10. The second composite material unit 22 and the third composite material unit 26 are arranged at an angle to the first composite material unit 14.

Typically, substantially the entire vessel wall 12 is configured by composite material units 14, 22, 26. The cylindrical vessel portion 10 is at least partially configured by the first composite material unit 14. The first composite material unit 14 has reinforcing fibers 16, in particular continuous reinforcing fibers, and a thermoplastic resin matrix 18, each of which is shown schematically. The first composite material unit 14 is arranged and configured such that the reinforcing fibers 16 are non-destructively removable.

The first composite material unit 14 extends from a first arrangement end 20 to a first arrangement start. When producing the pressure vessel 1, the first composite material unit 14 was arranged starting with the first arrangement start and then wrapped around the cylindrical vessel portion 10. The last arranged end of the first composite material unit 14 is the first arrangement end 20.

The second composite material unit 22 with the second arrangement end 24 is configured as a cross layer which wraps around the dome portions 6, 8 and the cylindrical vessel portion 10. The third composite material unit 26 with the third arrangement end 28 is configured as a local reinforcement layer in a highly stressed area of the dome section 6.

FIG. 2 shows a detailed view of the pressure vessel 1, wherein the longitudinal direction L is aligned orthogonally to the image plane and the cylinder circumferential direction U is aligned along the main extension direction of the first composite material unit 14. It can be seen that the composite material units 14, 22, 26 are arranged on a hollow body 32, which is also referred to as a liner. The hollow body 32 is not essential for forming the pressure vessel 1. For example, a pressure vessel 1 configured as type 5 does not have a hollow body 32.

Furthermore, the specific formation of the first arrangement end 20 is illustrated. A detachment section 34 of the first composite material unit 14 adjoins the first arrangement end 20. In particular, the detachment section 34 is arranged and configured such that it can be detached in a non-destructive manner.

The detachment section 34 extends from the first arrangement end 20 to the section end 36. A detachment layer 38 is arranged between the detachment section 34 and an underlying composite material unit. The detachment layer 38 may, for example, be a plastic that prevents a firm connection between the detachment section 34 and the underlying substrate, in particular a composite material unit, or reduces the connection strength.

FIG. 3 shows a detailed view of the detachment section 34, wherein the loose end 35 of the composite material unit 14 is arranged above the detachment layer 38. In addition or as an alternative to the detachment layer 38, it may be provided that the detachment section 34 is partially consolidated.

FIG. 4 shows a device 50 for carrying out a computer-implemented method for a digital image of a pressure vessel 1, comprising the steps of: receiving data characterizing a pressure vessel geometry, an arrangement end position, an arrangement direction, production parameters and/or machine parameters recorded during a producing of the pressure vessel 1, and generating the digital image based on the data characterizing the pressure vessel geometry, the arrangement end position, the arrangement direction, the production parameters and/or machine parameters recorded during a producing of the pressure vessel 1. For this purpose, the device 50 comprises a processor 52 for performing the steps of the computer-implemented method. The memory 54 may be adapted to store data received by the memory 54 from the processor and/or a transceiver 56.

FIG. 5 shows a schematic representation of an exemplary method. In step 100, a vessel wall 12 is formed with a composite material unit 14, 22, 26 comprising reinforcing fibers 16 and a thermoplastic resin matrix 18. The composite material unit 14, 22, 26 is arranged and configured such that the reinforcing fibers 16 are non-destructively removable.

Substantially simultaneously, in step 102, an arrangement end position of each of the arrangement ends 20, 24, 28 on the pressure vessel 1 is detected. In step 104, data characterizing the arrangement end positions is generated and provided.

In step 106, preferably also in parallel with one or more of the steps described above, an arrangement direction of the composite material unit 14, 22, 26 is detected and data characterizing the arrangement direction is generated and provided. In step 108, further composite material units are preferably arranged to produce a desired thickness of the vessel wall 12.

The pressure vessel 1 described in the foregoing has the particular advantage of being recyclable in a particularly simple manner. Due to the fact that the composite material units 14, 22, 26 are arranged and configured such that the reinforcing fibers 16 as continuous fibers and possibly the thermoplastic plastic matrix can be removed in a non-destructive manner, the composite material units 14, 22, 26 can be removed from the pressure vessel 1 in a particularly simple manner.

This significantly reduces the time required to recycle a pressure vessel 1 and reduces the manual effort required, so that the degree of automation can be increased. In particular, the provision of detachable arrangement ends 20, 24, 28 in the form of detachment sections 34 enables a pressure vessel 1 that is easier to recycle. Furthermore, by capturing and providing the arrangement ends 20, 24, 28, a possibility is provided that the positions of the arrangement ends 20, 24, 28 can be provided from a data memory when recycling the pressure vessel 1.

### REFERENCE SIGNS

1 pressure vessel
2 first container end
4 second container end
6 first dome section
8 second dome section
10 cylindrical vessel portion
12 vessel wall
13 container surface
14 first composite material unit
16 reinforcing fibers
18 thermoplastic matrix
20 first arrangement end
22 second composite material unit
24 second arrangement end
26 third composite material unit
28 third arrangement end
30 interior chamber
32 hollow body
34 detachment section
35 loose end of the composite material unit
36 section end
38 release layer
50 device
52 processor
54 memory
56 transceiver
L longitudinal direction
U cylinder circumferential direction

1. Pressure vessel with an interior chamber for storing hydrogen, comprising
a vessel wall comprising a composite material unit with reinforcing fibers and a thermoplastic polymer matrix,
wherein the composite material unit is arranged and configured such that the reinforcing fibers can be removed as continuous fibers, and non-destructively, so that the composite material unit can be reused.

2. Pressure vessel according to claim 1, wherein the composite material unit is arranged and configured such that the thermoplastic plastic matrix with the reinforcing fibers is removable.

3. Pressure vessel according to claim 1, wherein
the composite material unit extends from an arrangement start to an arrangement end, and
a detachment section of the composite material unit adjacent to the arrangement end is arranged and/or configured to be detachable.

4. Pressure vessel according to claim 3, wherein the detachment section comprises a strength-reducing detachment layer on a side of the composite material unit facing an interior chamber.

5. Pressure vessel according to claim 3, wherein the detachment section is partially consolidated so that a bond strength of the detachment section is lower than a bond strength of a consolidated section of the composite material unit.

6. Pressure vessel according to claim 3, wherein
the detachment section extends from the arrangement end with a detachment extension, and
the detachment extension is more than 1 mm, more than 2 mm, more than 5 mm, more than 10 mm and/or less than 100 mm, less than 50 mm, less than 25 mm, less than 15 mm, less than 10 mm.

7. Pressure vessel according to claim 1,
comprising two or more composite material units each having an arrangement end, and/or
wherein the composite material unit is a composite material web in the form of a processed prepreg.

8. Pressure vessel according to claim 1, comprising
a cylindrical vessel portion having a cylindrical circumferential direction,
wherein a first composite material unit is arranged along the cylindrical circumferential direction of the cylindrical vessel portion and a second composite material unit is arranged angled, in particular orthogonal to the cylindrical circumferential direction.

9. Pressure vessel according to claim 8, comprising two or more composite material units each having an arrangement end, wherein more than 50%, more than 75%, more than 90%, or more than 95% of the arrangement ends are arranged within the cylindrical vessel portion.

10. Pressure vessel according to claim 1, comprising two or more composite material units each having an arrangement end, wherein the arrangement ends are substantially evenly distributed along a container surface of the pressure vessel.

11. Pressure vessel according to claim 1, comprising a hollow body defining a liner forming an interior chamber, wherein one or more of the composite material units is or are arranged on an outer side of the hollow body.

12. Method for producing a pressure vessel having an interior chamber for storing hydrogen, comprising the step of:
Producing a vessel wall with a composite material unit with reinforcing fibers and a thermoplastic polymer matrix,
wherein the composite material unit is arranged and configured such that the reinforcing fibers are removable as continuous fibers, non-destructively.

13. Method according to claim 12, wherein the composite material unit has an arrangement end, comprising the steps of:
detecting an arrangement end position of the arrangement end on the pressure vessel, and
generating and providing data characterizing the arrangement end position.

14. Method according to claim 12, wherein the composite material unit is arranged with an arrangement direction, comprising the steps of:
detecting the arrangement direction of the composite material unit, and
generating and providing data characterizing the arrangement direction.

15. Method according to claim 13, comprising the step of:
Generating a digital image of the pressure vessel based on data characterizing the arrangement end position and/or based on data characterizing an arrangement direction of the composite material unit.

16. Method according to claim 12, wherein a plurality of composite material units each having an arrangement end are arranged with adjacent arrangement ends arranged side by side.

17. Computer-implemented method for a digital image of a pressure vessel, comprising the steps of:
Receiving data characterizing a pressure vessel geometry, an arrangement end position, an arrangement direction, manufacturing parameters and/or machine parameters detected during production of the pressure vessel, and
generating the digital image based on the data characterizing the pressure vessel geometry, the arrangement end position, the arrangement direction, the manufacturing parameters and/or machine parameters detected when producing the pressure vessel.

18. Computer program product comprising instructions which, when the instructions are executed by a processor, cause the processor to perform the steps of the computer-implemented method according to claim 17.

19. Computer-readable data carrier on which the computer program product according to claim 18 is stored.

20. Data structure characterizing a digital image of a pressure vessel obtained by a computer-implemented method according to claim 17.
